(19) United States
(12) Patent Application Publication
(10) Pub. No.: US 2017/0291236 A1
(43) Pub. Date: Oct. 12, 2017

(54) Modular Bow Saw

(71) Applicant: Pack Lite Tools LLC, Centennial, CO (US)

(72) Inventors: David Lindeman, Centennial, CO (US); Gary Benson, Centennial, CO (US); Timothy Kooser, Centennial, CO (US)

(73) Assignee: Pack Lite Tools LLC

(21) Appl. No.: 15/092,419

(22) Filed: Apr. 6, 2016

(51) Int. Cl. B23D 51/03; B23D 51/10

(52) U.S. Cl. CPC B23D 51/03; B23D 51/10

(57) ABSTRACT

A modular bow saw wherein the handle and bow can be separated for storage or transport.

### BACKGROUND

A saw is a very useful tool for people working or recreating in the wilderness. Trees, branches, and deadfalls may be cut for firewood, to reduce the risk of wildfire or construct fire breaks, to construct shelter, especially in an emergency, or to clear a trail, and thus are often used by campers, soldiers, firefighters, search and rescue teams, and forest workers. Hunters quartering game for transport also find saws convenient for rapidly cutting bone. However, saws suitable for use in a less remote environment have numerous problems when they must be transported long distances on foot. Most notably, they are both bulky and heavy, and the exposed teeth can cause damage to other items being carried, or injury to the user, if not handled carefully. These problems are exaggerated if multiple saws are carried for multiple purposes.

Various solutions have been attempted but have rendered unsatisfactory results. Folding saws that resemble large pocket knives are limited in size and stiffness of blade. They are necessarily heavier than regular saws of comparable size due to large handles into which the blade folds. Because American saws typically cut on the push stroke, thin, lightweight blades cannot be easily used alone. Nor can a standard saw be rolled up to save space, both because it is thicker and because it would be useless if curved. Thicker, stiffer saw blades make a larger kerf, removing more material, and therefore require more effort to operate. Wire saws do roll up compactly and have a narrow kerf, but are tricky to pack and unpack because of a tendency to tangle, and are relatively prone to breakage on the trail, making them more suitable for emergencies than regular use.

A bow saw, such as a coping saw or hacksaw, can solve some of these problems. Because the blades are held in tension by the bow, they can be thin and lightweight, allowing different blades for different jobs (for instance, wood, bone, and metal) to be carried easily. Blades can be coiled for compact packing because the bow will pull them straight in use, and they are also typically stronger than wire saws. The bow can be designed exclusively for strength without any concern for the effect its thickness will have on the kerf or ease of use.

The major obstacle to the use of bow saws in a backcountry environment is their size and weight. The handle and bow typically have dimensions similar to a small handsaw, which negates many possible advantages. What is needed, then, is a bow saw that can be made compact for transport yet still be sturdy enough for aggressive use and large enough to perform a wide variety of jobs.

### SUMMARY

A modular bow saw.

### BRIEF DESCRIPTION OF THE DRAWINGS

FIG. 1 is a plan view of one embodiment of a modular bow saw ready for use.

FIG. 2 is an enlarged cutaway view showing a tensioning mechanism for retaining a blade in a bow saw.

FIG. 3 is a plan view of one embodiment of a modular bow saw disassembled and ready to be packed.

FIG. 4 is a perspective view of two parts of one embodiment of a modular bow saw, positioned such that they may be mated for use.

FIG. 5 is a perspective view of two parts of a modular bow saw, mated together and ready for use.

FIG. 6 is a plan view showing one embodiment of a bayonet mount used to join the parts of a modular bow saw together.

FIG. 7 is a plan view of an alternative embodiment of a modular bow saw adapted for use by two people simultaneously.

### DETAILED DESCRIPTION

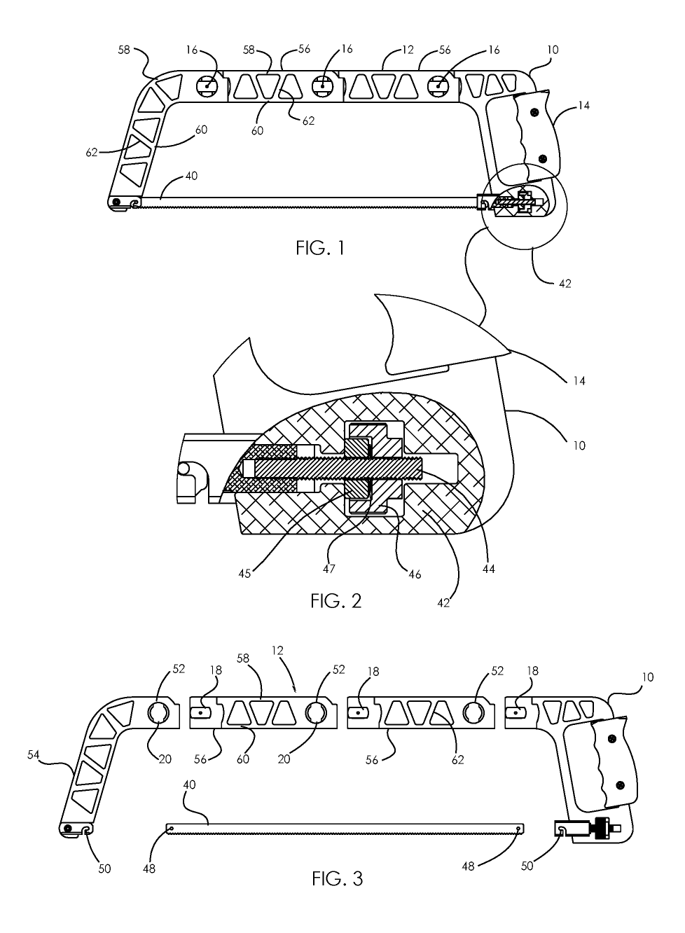

FIG. 1 depicts one embodiment of a trail-ready modular bow saw assembled and ready for use. The saw comprises a handle 10, and a bow 12. The handle 10 comprises a grip 14 which may be grasped by a user's hand, and an attachment point 16 that permits the bow 12 to be attached or removed from the handle 10. The attachment point 16 may comprise any secure means of attachment, such as a dovetail mount, a post with a cotter pin, or a threaded post and nut. In the preferred embodiment the attachment point 16 is a bayonet mount.

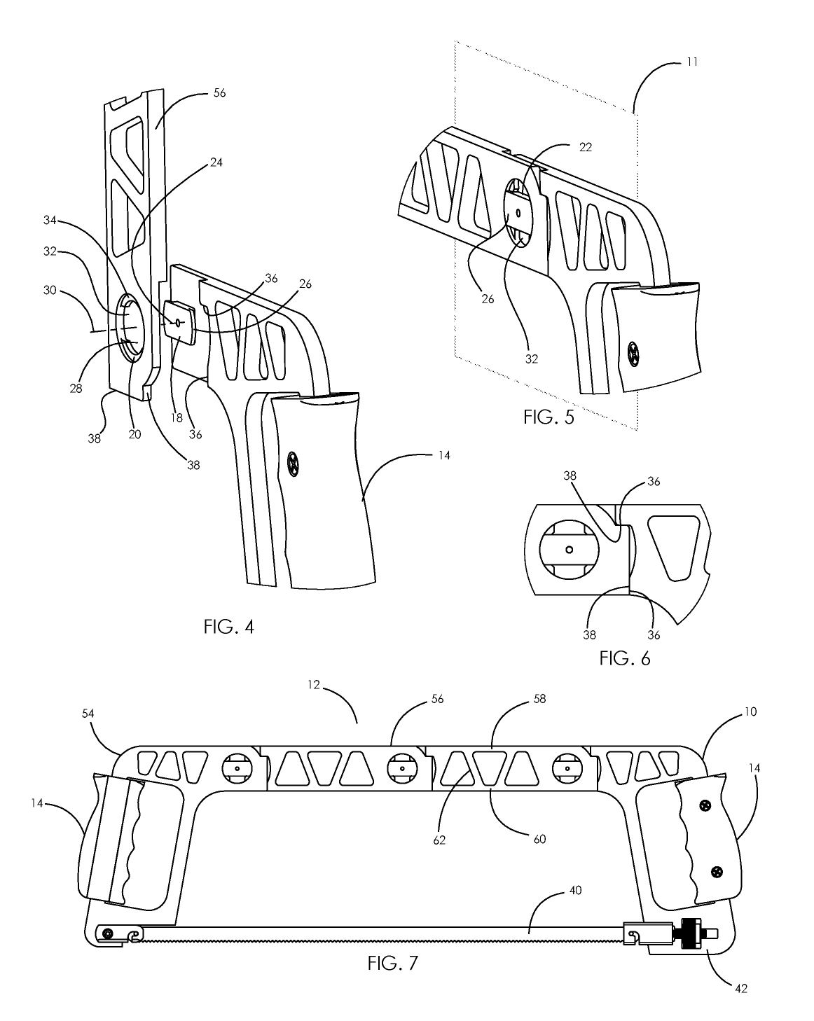

A bayonet mount, best shown in FIGS. 3 and 4, is a form of attachment comprising a male half 18 and a female half 20. The male half consists of a post 22 having an axis 24 and a plurality of post extensions 26 which extend from the post 22. There may be any number of post extensions 26 greater than one, and they may take any shape, including rods, wedges, or tabs, provided that they extend farther from the axis 24 than the post 22. Symmetry is not essential, and asymmetry may be used to force the parts to align in a particular way. In a preferred embodiment as shown in FIG. 4, the post extensions 26 take the form of flattened tabs, and there are two of them.

The female half 20 of a bayonet mount comprises a post-clearance hole 28 centered about an axis 30, a plurality of post-extension-clearance holes 32, and a post-extension-mating surface 34.

In use, the axes 24 and 30 are aligned with one another. The male and female halves 18 and 20 may then be rotated about their mutual axis 24, 30 until the post extensions 26 are aligned with the post-extension-clearance holes 32, as best shown in FIG. 4. This allows the two halves to be brought together, with the post 22 passing through the post-clearance-hole 28 and the post extensions 26 passing through the post-extension-clearance holes 32. Then the two halves may be rotated about their mutual axis 24, 30 so that the post extensions 26 are no longer aligned with the post-extension-clearance holes 32, but rather are aligned with the post-extension-mating surface 34, as best shown in FIG. 5. In this position, it is no longer possible to separate the male half 18 from the female half 20.

As is typical in the art of bow saws, the blade 40 is held in place by tension. This tension is provided by a tensioning mechanism 42, best shown in FIG. 2. A threaded rod 44 is operatively connected to the blade 40, and a nut 46 can be tightened against the handle 10 to pull the blade 40 into tension. This mechanism is well known in the art. However, it has been found advantageous to use a Belleville washer 47 between the nut 46 and the handle 10 in order to provide preload and prevent loosening of the nut 46. A conventional washer 45 may also be inserted to reduce wear on the handle 10 and facilitate turning of the nut 46. As the saw is worked back and forth by the user, the force exerted by the nut 46 varies. When the blade is pushed into the material to be cut, tension is lowest, and may even be so low that the nut 46 or washer 45 loses contact with the handle 10, allowing the nut 46 to loosen. By using a Belleville washer 47 that provides a spring force against the nut 46, friction is maintained so that the nut 46 does not turn in use.

As depicted in FIG. 3, the blade 40 has pins 48 at either end, which engage hooks 50 on the bow. It is also possible for the blade to have holes that engage pins mounted on the bow (not shown) or for clamp mechanisms to grip blade 40 by friction (not shown). The exact means of securing the blade is not important as long as sufficient tension can be provided.

When assembled, the bow 12 and handle 10 lie substantially in plane 11. In a preferred embodiment, the axes 24, 30 are substantially perpendicular to this plane 11. It will be appreciated that when tension is applied to the blade 40, a torque is exerted about the axis 30, 24 of the bayonet mount. It is therefore necessary to stop the mutual rotation of the both halves of the bayonet mount at a chosen point. This may be achieved by various means, including limiting extent of the post-extension-mating surface 34 so that the post extensions 26 contact an impediment to rotation. However, that method leaves the relatively thin post extensions 26 to bear the force of rotation, which in the case of a bow saw can be substantial. Therefore, a preferred embodiment features a shelf 36 on the male half 18 of the bayonet mount and a corresponding shelf 38 on the female half of the bayonet mount. A most preferred embodiment, featuring a plurality of shelves 36, 38 on each half of the bayonet mount, is best shown in FIG. 6. When the halves of the bayonet mount are mated and rotated, the shelves 36, 38 come into contact with one another and prevent rotation beyond a predetermined angle. This angle is selected to allow the full engagement of the post extensions 26 with the post-extension-mating surface 34, so that the attachment point 16 cannot be easily separated. With tension on the blade 40, the bayonet mount depicted in the drawings forms a very rigid connection that is sturdy enough to allow the saw to be used for cutting, and cannot become detached unless the blade 40 is first removed.

The bow 12 comprises a mating attachment point 52, which is selected to correspond to the attachment point 16 of the handle 10. As discussed above, in a preferred embodiment, the attachment point 16 and the mating attachment point 52 are the two halves of a bayonet mount. In a preferred embodiment, the bow 12 further comprises a distal end segment 54, which is designed to attach to one end of the blade 40. The other end of the blade 40 attaches to the handle 10. The bow 12 may further comprise one or more intermediate segments 56, which serve to increase the distance between the distal end segment 54 and the handle 10, to allow for a longer blade 40. These intermediate segments 56 may be manufactured in different lengths for different blades 40, and more than one intermediate segment 56 may be used to minimize packing dimensions and allow for a longer blade 40.

In a most preferred embodiment, the distal end segment 54 has a half of a bayonet mount selected to mate with the half of a bayonet mount found on the handle 10. Each intermediate segment 56 has one female and one male half of a bayonet mount (20 and 18), on opposite ends. In this way, any intermediate segment 56, or a plurality of intermediate segments 56, may be interposed between the handle 10 and the distal end segment 54 without any need to search and find the “correct” combination. All combinations are functional. It does not matter, in this embodiment, whether the handle 10 or the distal end segment 54 has the male half 18, as long as the other one of the pair has the female half 20.

In another embodiment, best shown in FIG. 7, the distal end segment 54 comprises a grip 14. In this way two people may hold the saw in order to apply more force and cut more rapidly. It is also possible to use two handles 10, one on each end of the bow 12, but it will be appreciated that that the intermediate segments 56 used between must be capable of attachment to both handles 10. Thus the combination of male 18 and female 20 halves may differ from that shown. It will also be appreciated that the distal end segment 54 differs from the handle in the absence of the tensioning mechanism 42, and therefore it is not practical to use two distal end segments 54, even if it is possible to assemble a saw in that way. It may be convenient to mark the handles 10, intermediate segments 56, and distal ends 54 in such a way that compatibility is immediately clear, such as by color coding. Then when a crew or platoon arrives at a location where multiple saws are to be used, they may assemble them all without delay.

The bow 12 itself must be stiff for the saw to function. Traditional bow saws use steel bows for strength. However, steel is heavy. Titanium is quite desirable for its light weight, and is most preferred from a purely functional standpoint. However, aluminum is preferred when cost must be taken into account. In order to make an aluminum bow 12 stiff without unnecessary weight, a truss structure is helpful. Trusses are well known in the construction arts, and used for spanning large spaces in such diverse applications as warehouse roofs, radio towers, and automotive or railroad bridges. The truss structure comprises an outside stringer 58 and an inside stringer 60, the stringers running substantially parallel to one another and both lying substantially in the plane 11, with ribs 62 running between them. In a preferred embodiment the ribs 62 are not perpendicular to the rails, but rather form triangles. In this way the bow 12 is stiff but also lightweight. The bow 12 may be formed by any conventional means, such as welding, brazing, or riveting. In a preferred embodiment it is formed from a single piece of material. This may be accomplished by casting, machining, laser cutting, 3D printing, waterjet cutting, stamping, or any other means that gives sturdy results.

The foregoing description and drawings are presented only for the purpose of illustration. The invention is limited only by the claims, which follow.

1. A bow saw, comprising a handle and a bow, wherein the bow comprises a distal end segment, wherein the handle comprises half of a bayonet mount.

2. The saw of claim 1 wherein the distal end segment further comprises a half of a bayonet mount.

3. The saw of claim 2 where in the half of a bayonet mount found in the distal end segment is selected and sized to mate with the half of a bayonet mount found the handle.

4. The saw of claim 3 wherein each half of the bayonet mount includes a shelf for making contact with a corresponding shelf on the other half, to limit the rotation of the halves relative to one another to a predetermined angle.

5. The saw of claim 1 further comprising at least one intermediate segment, the intermediate segment having at least one half of a bayonet mount attached to it.

6. The saw of claim 5 wherein the intermediate segment comprises two ends, each end having a half of a bayonet mount attached proximal to it.

7. The saw of claim 6 wherein one of the ends has a female half of a bayonet mount and the other end has a male half of a bayonet mount.

8. The saw of claim 7 wherein the handle, the intermediate segment, and the distal end, when in use, all lie substantially in a plane, and wherein the bayonet mount has an axis of rotation that is substantially perpendicular to the plane.

9. The saw of claim 5 wherein the intermediate segment is capable of simultaneous attachment to the distal end segment and the handle.

10. A bow saw, comprising a handle and a bow, wherein the bow comprises a distal end segment and at least one intermediate segment, and wherein the handle, distal end segment, and intermediate segment may be attached to one another for use, or separated for transport or storage.

11. The saw of claim 10 wherein the method of attachment between at least two of the handle, distal end segment, and intermediate segment comprises a bayonet mount.

12. The saw of claim 11 where in the method of attachment between the handle, intermediate segment, and distal end segment consists of a plurality of bayonet mounts.

13. The saw of claim 12 wherein the intermediate segment has a first end and a second end, and has a female half of a bayonet mount at the first end and a male half of a bayonet mount at the second end.

14. The saw of claim 11 wherein the handle has one half of a bayonet mount and the distal end segment has a corresponding half of a bayonet mount, so that the distal end segment may be secured directly to the handle.

15. The saw of claim 11 wherein the bow comprises a plurality of intermediate segments

16. The saw of claim 11 wherein the bayonet mount comprises two halves, at least one of the halves having a shelf, the shelf being so configured as to halt the rotation of the two halves relative to one another when the two halves are joined and rotated through a predetermined angle.

17. The saw of claim 16 wherein each of the two halves has a shelf, the shelves being configured so as to contact one another after the two halves have rotated through the predetermined angle.

18. The saw of claim 17 wherein each of the two halves has a plurality of shelves so configured as to allow contact in a plurality of locations.

19. The saw of claim 11 wherein the distal end segment, intermediate segment, and handle, when joined, lie substantially in a plane, and the bayonet mount has an axis of rotation that is substantially perpendicular to the plane.
